(19) United States
(12) Patent Application Publication
(10) Pub. No.: US 2020/0200621 A1
(43) Pub. Date: Jun. 25, 2020

(54) MODELING NONLINEAR CHARACTERISTICS OF MATERIALS FOR SENSOR APPLICATIONS

(71) Applicant: BeBop Sensors, Inc., Berkeley, CA (US)

(72) Inventors: Conner Lacy, Charlottesville, VA (US); Brandon Kuhnert, Lake Oswego, OR (US); Keith A. McMillen, Berkeley, CA (US)

(21) Appl. No.: 16/692,626

(22) Filed: Nov. 22, 2019

Related U.S. Application Data
(60) Provisional application No. 62/782,644, filed on Dec. 20, 2018.

(51) Int. Cl. G01L 1/22; G06N 3/08; G06N 20/00

(52) U.S. Cl. CPC G01L 1/2256; G06N 20/00; G06N 3/08; G01L 1/2281

(57) ABSTRACT

Methods and apparatus are described that employ machine learning techniques to model nonlinear properties of materials employed in sensor devices and systems to improve the operation of such devices and systems.

### INCORPORATION BY REFERENCE

An Application Data Sheet is filed concurrently with this specification as part of this application. Each application to which this application claims benefit or priority as identified in the concurrently filed Application Data Sheet is incorporated by reference herein in its entirety and for all purposes.

### BACKGROUND

Materials that exhibit measurable changes in response to applied force can be useful for implementing force sensors. Such materials include piezoresistive materials which exhibit changes in electrical resistance in response to mechanical stress. One issue in implementing sensors based on such materials relates to the nonlinear characteristics exhibited by some materials. That is, some of these materials exhibit nonlinear responses to force over various parameter ranges including, for example, the range of the force itself, the type of force, the duration of the force, temperature, humidity, etc. This may particularly be the case with materials that have viscoelastic properties.

Viscoelasticity is the term for materials that exhibit both viscous and elastic characteristics when undergoing deformation. A viscous material resists shear flow and strain linearly with time when stress is applied. An elastic material strains when stretched and returns to its original state once the stress is removed. And because thermal motion is one factor contributing to the deformation of some materials, the viscoelastic properties of a material can change with significantly with temperature. Further, when subjected to constant stress, viscoelastic materials often experience a time-dependent increase in strain commonly referred to as “viscoelastic creep.” Such nonlinear characteristics are problematic in the design of sensor systems that include viscoelastic materials. Moreover, conventional models of viscoelastic systems that employ combinations of dashpots (representing viscous behaviors) and springs (representing linear elastic behaviors) may not be sufficient for many applications.

### SUMMARY

According to a particular class of implementations, a device includes a sensor, and the sensor includes a component characterized by a nonlinear characteristic. Sensor circuitry is configured to receive a sensor signal from the sensor. The sensor signal represents a force on the sensor. The sensor circuitry includes memory having sensor model data stored therein. The sensor model data represent a sensor model. The sensor model represents sensor behavior that reflects the nonlinear characteristic of the component. The sensor circuitry is configured to generate a force value based on the sensor signal and the sensor model data. The force value represents the force on the sensor.

According to a specific implementation of this class, the sensor model represents the sensor behavior over one or more of a range of temperature, a range of pressure, or a range of humidity.

According to another specific implementation of this class, the sensor model data are stored in a table that relates digital representations of the sensor signal to force values. The sensor circuitry is configured to generate the force value by selecting the force value from the table based on at least one digital representation of the sensor signal.

According to another specific implementation of this class, the sensor circuitry is configured to generate a plurality of digital values based on the sensor signal over time. The sensor circuitry is configured to generate the force value based on a current digital value of the plurality of digital values and a previous digital value of the plurality of digital values. According to a more specific implementation, the previous digital value corresponds to a most recent time at which a previous force above a specified threshold was exerted on the sensor. According to another more specific implementation, the sensor circuitry is configured to generate the force value based on a difference between the current digital value and the previous digital value.

According to another specific implementation of this class, the sensor circuitry is configured to generate the force value based on a temperature value representing a temperature.

According to another specific implementation of this class, the sensor model data represent a plurality of sensor models. The sensor circuitry includes logic configured to select one of the sensor models for generation of the force value based on a state derived from the sensor signal.

According to another specific implementation of this class, the sensor circuitry includes a filter and logic configured to select or modify the filter for generation of the force value based on a state derived from the sensor signal.

According to another specific implementation of this class, the sensor circuitry is configured to generate a plurality of digital values based on the sensor signal over time. The sensor circuitry is configured to generate the force value by locking the force value to a previously generated force value if a statistical characteristic of a set of the digital values exceeds a threshold.

According to another specific implementation of this class, the sensor circuitry is configured to generate a plurality of digital values based on the sensor signal over time. The sensor circuitry is configured to generate the force value by applying a scaling function to digital values.

According to another specific implementation of this class, the nonlinear characteristic of the component comprises viscoelasticity.

According to another class of implementations, known forces are exerted on a sensor of a sensor type. The sensor includes a component characterized by a nonlinear characteristic. Digital values resulting from the known forces are received. Training vectors are generated using the digital values. A machine learning algorithm is trained using the training vectors and the known forces, thereby resulting in sensor model data representing a sensor model. The sensor model represents sensor behavior that reflects the nonlinear characteristic of the component. The sensor model data are stored in a memory of a device that includes an instance of the sensor type.

According to a specific implementation of this class, a linearizing technique is applied to the digital values before generating the training vectors. According to a more specific implementation, the linearizing technique includes an exponential scaling function.

According to another specific implementation of this class, a plurality of states are determined based on the digital values. Training the machine learning algorithm results in the sensor model data representing a plurality of sensor models. Each sensor model corresponds to one of the states.

According to another specific implementation of this class, the training vectors include a plurality of features. Training the machine learning algorithm includes determining weights for each of the features such that the sensor model data associate force values with each of the training vectors that accurately represent the corresponding known forces within a specified tolerance.

According to another specific implementation of this class, each training vector includes a current digital value of the digital values and a previous digital value of the digital values. According to a more specific implementation, each training vector also includes a difference between two of the digital values. According to another more specific implementation, each training vector also includes a temperature value representing a temperature. According to yet another more specific implementation, the previous digital value corresponds to a most recent time at which one of the known forces above a specified threshold was exerted on the sensor.

According to another specific implementation of this class, the nonlinear characteristic of the component comprises viscoelasticity.

A further understanding of the nature and advantages of various implementations may be realized by reference to the remaining portions of the specification and the drawings.

### BRIEF DESCRIPTION OF THE DRAWINGS

FIG. 1 depicts a sensor system that employs one or more sensor models enabled by the present disclosure.

FIG. 2 depicts an example of the layers of a particular implementation of a sensor system.

FIG. 3 is a simplified diagram of sensor circuitry for use with particular implementations enabled by the present disclosure.

FIG. 4 is a flowchart illustrating operation of a machine learning algorithm enabled by the present disclosure.

### DETAILED DESCRIPTION

This disclosure describes devices and systems that employ sensor technology. According to various implementations enabled by the present disclosure, techniques for modeling nonlinear properties of materials are provided for improving the operation of such sensor devices and systems. Specific implementations are described herein including the best modes contemplated. Examples of these implementations are illustrated in the accompanying drawings. However, the scope of this disclosure is not limited to the described implementations. Rather, this disclosure is intended to cover alternatives, modifications, and equivalents of these implementations. In the following description, specific details are set forth in order to provide a thorough understanding of the described implementations. Some implementations may be practiced without some or all of these specific details. In addition, well known features may not have been described in detail to promote clarity.

Some implementations described herein relate to sensor devices or systems that include piezoresistive materials. Piezoresistive materials include any of a class of materials that exhibit a change in electrical resistance in response to mechanical force (e.g., pressure, impact, distortion, etc.) applied to the material. One class of devices described herein includes conductive traces formed directly on or otherwise integrated with a dielectric substrate with piezoresistive material that is adjacent and/or tightly integrated with the dielectric substrate and in contact with at least some of the traces on the dielectric. Another class of devices described herein includes conductive traces formed directly on or otherwise integrated with a substrate of piezoresistive material, e.g., a piezoresistive fabric. When force is applied to such either type of device, the resistance between traces connected by the piezoresistive material changes in a time-varying manner that is representative of the applied force.

A signal representative of the magnitude of the applied force is generated based on the change in resistance. This signal is captured via the conductive traces (e.g., as a voltage or a current), digitized (e.g., via an analog-to-digital converter), processed (e.g., by an associated processor, controller, or suitable circuitry), and mapped (e.g., by the associated processor, controller, or circuitry, or a separate control system) to a control function that may be used in conjunction with the control and/or operation of virtually any type of process, device, or system. For implementations described herein such control functions include generation of audio representations of percussion instruments.

According to some implementations, the piezoresistive material with which the traces are in contact or on which the traces are formed may be any of a variety of woven and non-woven fabrics having piezoresistive properties. Implementations are also contemplated in which the piezoresistive material may be any of a variety of flexible, stretchable, or otherwise deformable materials (e.g., rubber, or a stretchable fabric such as spandex or open mesh fabrics) having piezoresistive properties. The conductive traces may be formed on the dielectric substrate or the piezoresistive material using any of a variety of conductive inks or paints. More generally, implementations are contemplated in which the conductive traces are formed using any conductive material that may be formed on either type of substrate. It should be understood with reference to the foregoing that, while specific implementations are described with reference to specific materials and techniques, the scope of this disclosure is not so limited.

According to a particular class of implementations, the piezoresistive material is a pressure sensitive fabric manufactured by Eeonyx, Inc., of Pinole, Calif. The fabric includes conductive particles that are polymerized to keep them suspended in the fabric. The base material (which may be, for example, a polyester felt) is selected for uniformity in density and thickness as this promotes greater uniformity in conductivity of the finished piezoresistive fabric. That is, the mechanical uniformity of the base material results in a more even distribution of conductive particles when the slurry containing the conductive particles is introduced. In some implementations, the fabric may be woven. Alternatively, the fabric may be non-woven such as, for example, a calendared fabric, e.g., fibers bonded together by chemical, mechanical, heat, or solvent treatment. For implementations in which conductive traces are formed on the piezoresistive fabric, calendared material may present a smooth outer surface which promotes more accurate screening of conductive inks.

The conductive particles in the fabric may be any of a wide variety of materials including, for example, silver, copper, gold, aluminum, carbon, etc. Some implementations may employ carbon graphene particles. Such materials may be fabricated using techniques described in U.S. Pat. No. 7,468,332 for Electroconductive Woven and Non-Woven Fabric issued on Dec. 23, 2008, the entire disclosure of which is incorporated herein by reference for all purposes. However, it should again be noted that any of a wide variety of materials that exhibit a change in resistance or conductivity when force is applied to the material may be suitable for implementation of sensors as described herein.

According to a particular class of implementations, conductive traces having varying levels of conductivity are formed on a dielectric substrate or piezoresistive material using conductive silicone-based inks manufactured by, for example, E.I. du Pont de Nemours and Company (DuPont) of Wilmington, Del., and/or Creative Materials of Ayer, Mass. An example of a conductive ink suitable for implementing highly conductive traces for use with various implementations is product number 125-19 from Creative Materials, a flexible, high temperature, electrically conductive ink. Examples of conductive inks for implementing lower conductivity traces for use with various implementations are product numbers 7102 and 7105 from DuPont, both carbon conductive compositions. Examples of dielectric materials suitable for implementing insulators for use with various implementations are product numbers 5018 and 5036 from DuPont, a UV curable dielectric and an encapsulant, respectively. These inks are flexible and durable. The degree of conductivity for different traces and applications may be controlled by the amount or concentration of conductive particles (e.g., silver, copper, aluminum, carbon, etc.) suspended in the silicone. These inks can be screen printed or printed from an inkjet printer. According to some implementations, the substrate on which the inks are printed are non-stretchable allowing for the use of less expensive inks that are low in flexibility and/or stretchability. Another class of implementations uses conductive paints (e.g., carbon particles mixed with paint) such as those that are commonly used for EMI shielding and ESD protection.

Additional examples of sensor technology and related techniques that may be used with various implementations enabled by the present disclosure are described in U.S. Pat. No. 8,680,390 entitled Foot-Operated Controller issued on Mar. 25, 2014, U.S. Pat. No. 9,076,419 entitled Multi-Touch Pad Controller issued on Jul. 7, 2015, U.S. Pat. No. 9,965,076 entitled Piezoresistive Sensors and Applications issued on May 8, 2018, U.S. Pat. No. 9,442,614 entitled Two-Dimensional Sensor Arrays issued on Sep. 13, 2016, U.S. Pat. No. 9,863,823 entitled Sensor Systems Integrated With Footwear issued on Jan. 9, 2018, U.S. Pat. No. 10,362,989 entitled Sensor System Integrated With a Glove issued on Jul. 30, 2019, and U.S. Pat. No. 9,721,553 entitled Sensor-Based Percussion Device issued on Aug. 1, 2017. The entire disclosure of each of the foregoing patent documents is incorporated herein by reference for all purposes. However, it should also be noted that implementations are contemplated that employ other suitable sensor technologies in a wide variety of applications. The scope of this disclosure should therefore not be limited by reference to these examples.

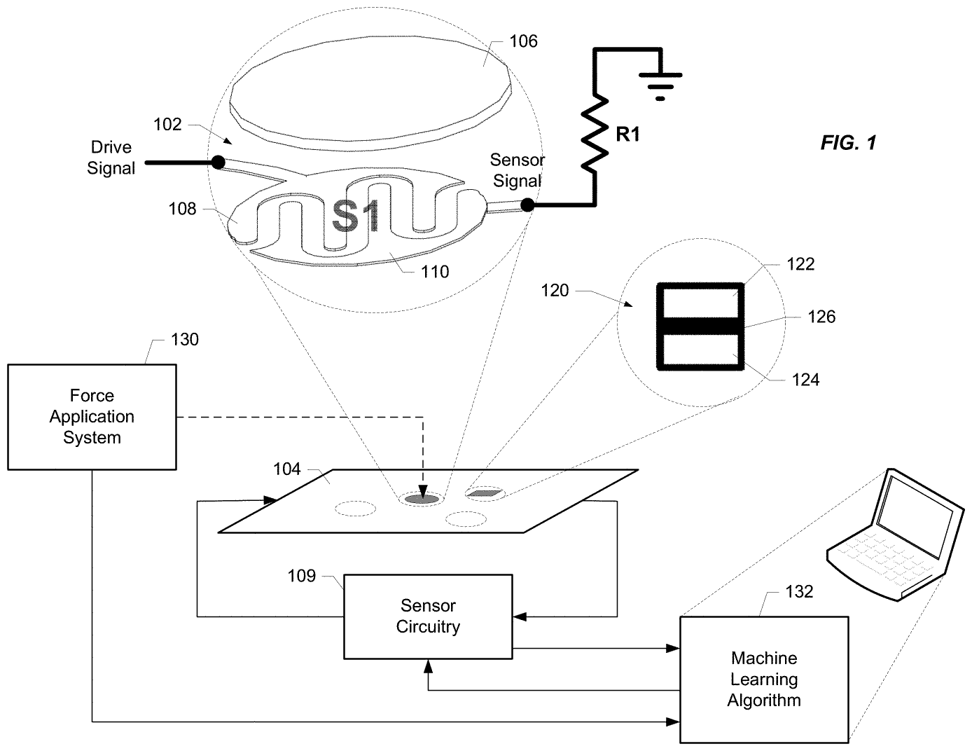

An implementation will now be described in which a machine learning model is generated that represents the behavior of a sensor. FIG. 1 illustrates an example of sensor system enabled by the present disclosure. One or more sensors are implemented with conductive trace patterns 102 that are formed directly on or otherwise integrated with a substrate 104. In the depicted implementation, substrate 104 is a dielectric material. At each sensor location, a patch 106 of a flexible piezoresistive material is tightly integrated with dielectric material 104 such that it makes contact with a corresponding one of the sensor trace patterns 102 thereby forming the sensor. Piezoresistive material 106 may be, for example, a piezoresistive fabric as described above.

Each of sensor trace patterns 102 (as shown in the exploded view of sensor S1) includes two closely spaced traces, the respective patterns of which include extensions that alternate. One of the traces 108 receives a drive signal from associated sensor circuitry 109. The other trace 110 transmits the resulting sensor signal to sensor circuitry 109. The drive signal might be provided, for example, by connecting the trace (permanently or temporarily) to a voltage reference, a signal source that may include additional information in the drive signal, a GPIO (General Purpose Input Output) pin of a processor or controller in sensor circuitry 109, etc. And as shown in the example in FIG. 1, the sensor signal might be generated using a voltage divider in which one of the resistors of the divider includes the resistance between the two traces through the intervening piezoresistive material. The other resistor (represented by R1) might be included, for example, as part of sensor circuitry 109. As the resistance of the piezoresistive material changes with applied force, the sensor signal also varies as a divided portion of the drive signal. Each sensor on substrate 104 is energized (via a corresponding drive signal) and interrogated (via a corresponding sensor signal) to generate an output signal that is a representation of the force exerted on that sensor. As will also be appreciated, and depending on the application, implementations are contemplated having many sensors or as few as one sensor.

According to a particular implementation, trace patterns 102 are screen printed on substrate 104 which may be a flexible PET (polyethylene terephthalate) substrate about 5 mils thick. The PET has conductive traces as well as dielectric insulating material at locations at which the traces cross each other, allowing for complicated patterns and routing to isolated structures. According to a specific implementation, the traces are formed using a silk screening process which deposits ink1, dielectric, then ink2. As will be appreciated, more complicated topologies are contemplated.

Piezoresistive patch 106 may be adhered to an additional substrate (not shown) which may be a non-permeable, flexible material such as, for example, a thermally transferable polyurethane or TPU, such as those available from Bemis Associates Inc. of Shirley, Mass. Piezoresistive patch 106 may be adhered to the TPU by selective heating or using a suitable adhesive, e.g., a dot of glue. In another example, the piezoresistive patches could be punched with an adhesive on the back (e.g., a pressure sensitive adhesive such as 3M 468MP commonly referred to as double sided tape). According to a particular implementation, a stacked adhesive is used that includes, from the piezoresistive patch down: 3M 468, 0.05 PET, and acrylic PSA, which is bonded to the TPU of the additional substrate. Alternatively, the additional substrate could be a PET substrate with pressure sensitive adhesive applied to one surface for adhering the piezoresistive patch and then for adhering to substrate 104.

The additional substrate with one or more patches 106 is positioned relative to substrate 104 so patches 106 line up with sensor trace patterns 102. The substrates are then thermally pressed together so the additional substrate melts into substrate 104 (for implementations in which the additional substrate is a TPU), forming a hermetic seal around each of the sensors (i.e., a piezo patch and the corresponding trace pattern) and routing traces leading to the sensor circuitry. The seal provides environmental protection for the sensors and traces and helps hold the individual sensor components in position resulting in a robust and tightly integrated unit. Environmental protection can be particularly advantageous for the conductive inks from which the sensors and traces are constructed given their tendency to oxidize and degrade over time when exposed to various environmental contaminants. As will be appreciated, the number and configuration of sensors may vary depending, for example, on the particular application, desired resolution, etc.

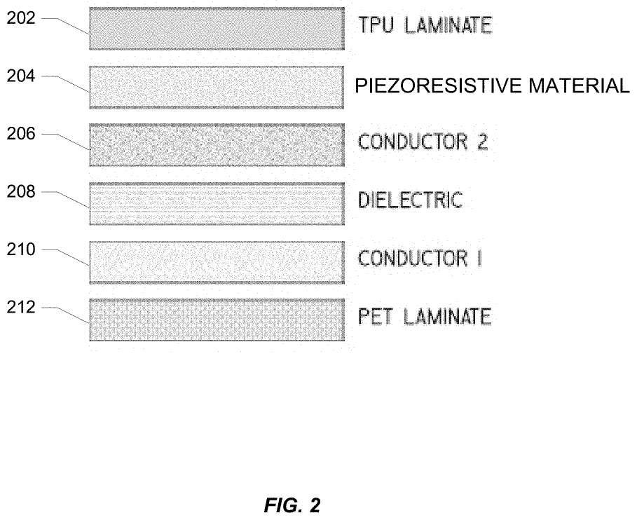

FIG. 2 shows different assembly layers that may exist at or near one of the sensors according to some implementations. These include the upper substrate (TPU laminate 202), the piezoresistive element (fabric 204), one trace (conductor 206), an insulator for where the traces might overlap (dielectric 208), another trace (conductor 210), and the lower substrate (PET laminate 212). As will be appreciated, depending on the location in the assembly, only a subset of the depicted layers will be present. For example, the piezoresistive material will only be at the locations of the sensors. In another example, along one of the routing traces there might only be the upper substrate, one conductor, and the lower substrate. In another example, between the traces of a particular sensor, a cross-section would show only the piezoresistive fabric and the two laminates. In another example that includes thermocouples, additional layer types corresponding to the thermocouple structure would be present. Other variations will be appreciated by those of skill in the art.

The sensors depicted in FIGS. 1 and 2 may have nonlinear characteristics that, without the techniques described herein, might result in inaccurate or unreliable operation in terms of the forces detected and reported by the sensors. For example, for implementations in which the sensors are based on piezoresistive fabric, the fabric may be characterized by viscoelasticity that makes the behavior of the fabric nonlinear in multiple respects. The response of the fabric may vary nonlinearly depending on the scale of force, the speed and/or acceleration of the input, how long the fabric is activated, temperature, pressure, humidity, etc.

In addition, the extent to which the characteristics and response of the material vary may be application specific. The applications described in the patent documents incorporated by reference above provide examples of applications in which the expected forces may vary significantly from each other. For example, for a device that emulates a drum, the expected forces applied may be very sharp with fast attack times. By contrast, for a sensor in a glove or footwear insole, slower developing and/or more sustained inputs might be expected. Moreover, the physical parameters around a sensor in a particular application might be highly dynamic. All of these factors make it clear that a single conventional model for such a material will not be appropriate or sufficient to support a wide range of applications. However, as will be discussed, the sensor models enabled by the present disclosure can be tailored to support such a range of applications.

Referring again to FIG. 1, the sensor system may include one or more temperature sensors such as, for example, thermocouple 120. A thermocouple is an electrical device including two dissimilar conductors having an electrical junction that generates a temperature-dependent voltage as a result of the thermoelectric effect. This voltage can be used to measure temperature. Some conventional thermocouples are built by welding, for example, a copper wire to a nickel wire. As the combination is heated or cooled it produces a small amount of electricity representative of the temperature.

According to the particular implementation illustrated in FIG. 1, thermocouple 120 includes two dissimilar metals 122 and 124 provided on or near substrate 104 so that the temperature of the system can be monitored. One of the thermocouple metals may be, for example, a powdered metal (e.g., nickel, steel, constantan, or the like) dispersed in an ink composition with a sufficiently high concentration. This component of the thermocouple may be screen printed (e.g., on substrate 104) in conjunction with the printing of the conductors and insulators of the sensors. The other metal component of the thermocouple (e.g., a copper film) may be adhered to the additional substrate on which the piezoresistive patches are adhered as described above, with the contact between the two thermocouple components being made when the substrates are aligned and secured to each other. Black strip 126 represents the region of overlap of the two metals. According to a particular implementation, in which the substrate to which the copper film is adhered is a TPU, securing the two substrates together provides sufficient pressure to electrically connect the two thermocouple components. Each of the thermocouples has its own set of traces (not shown for clarity) that are routed to the sensor circuitry. It should be noted that other thermally responsive devices may be used as temperature sensing elements for monitoring system temperatures including, for example, resistance temperature detectors (RTDs) which measure temperature by correlating the resistance of the RTD element (usually a pure metal such as nickel or copper) with temperature, or thermistors which use a ceramic or a polymer that changes resistance with temperature. Other suitable devices are known to those of skill in the art.

For examples of thermocouple structures that may be used with various implementations, please refer to U.S. Pat. No. 4,438,291 entitled Screen-Printable Thermocouples issued Mar. 20, 1984, Eichelberger et al., the entire disclosure of which is incorporated herein by reference for all purposes.

According to some implementations, other types of sensors (represented by the additional dashed circles on substrate 104) may be provided that are responsive to additional parameters such as, for example, barometric pressure and humidity. Barometric pressure may be measured using any of a wide variety of sensors such as, for example, the KP254 from Infineon Technologies AG, a miniaturized digital barometric air pressure sensor. Humidity may be measured using any of a wide variety of sensors such as, for example, the HDC2080DMBT sensor from Texas Instruments, or the HCZ-H8-B sensor from the Multicomp group of Newark. The appropriate sensor for each of these parameters would depend on the application and the intended environment.

According to some implementations, parameters such as temperature, pressure, and humidity may be integrated with the sensor models generated as described herein. According to others, one or more of such parameters may be handled separately (e.g., using a state machine, RSM logic, etc.) to select between models and/or modify information processing pipelines. Such an alternate approach might be appropriate for a given parameter where, for example, the changes in the parameter would need to be very large to have a significant effect on the sensor(s) being modeled.

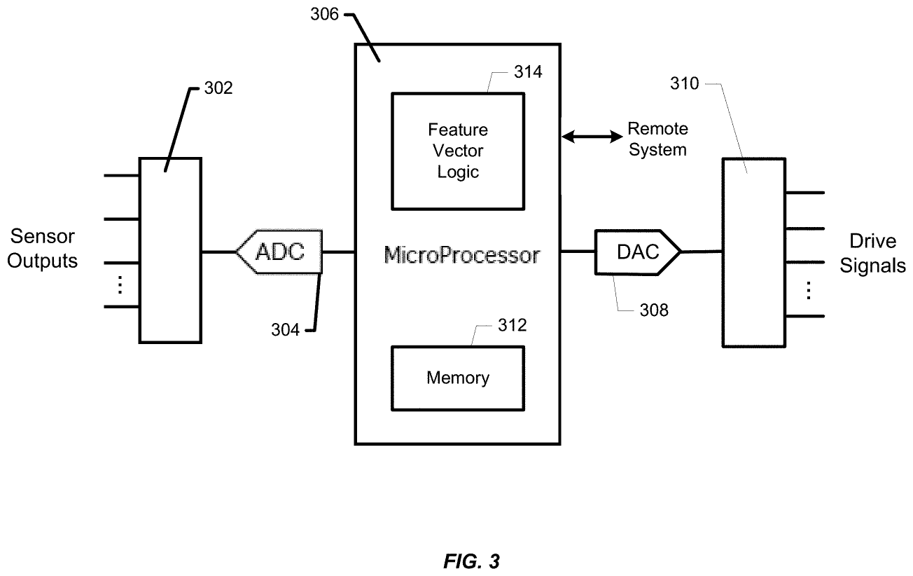

FIG. 3 is a simplified diagram of an example of sensor circuitry (e.g., 109) that may be provided on a PCB or other assembly connected to or integrated with the sensor system. For example, in the implementation depicted in FIG. 1, such sensor circuitry could be connected to the conductive traces on substrate 104. When pressure is applied to one of the sensors, a resulting signal (captured via the corresponding traces) is received and digitized (e.g., via multiplexer 302 and analog-to-digital converter (ADC) 304) and may be processed locally (e.g., by processor 306) and/or transmitted to a connected device (e.g., via a wired or wireless connection). The sensors may be selectively energized by the sensor circuitry (e.g., under the control of processor 306 via digital-to-analog converter (DAC) 308 and multiplexer 310) to effect the generation of the sensor signals. Processor 306 may communicate with a remote system via a wired or wireless interface. Power may be provided to the sensor circuitry using any of a variety of mechanisms including one or more batteries, a connection to an external electrical system, energy harvested from the system's environment, etc. And as will be appreciated, the sensor circuitry shown in FIG. 3 is merely an example. A wide range of sensor circuitry components, configurations, and functionalities are contemplated.

The sensor circuitry depicted in FIG. 3 includes memory 312 in which, potentially among other data, sensor model data are stored. These sensor model data represent one or more sensor models enabled by the present disclosure and, as will be described, are used by microprocessor 306 to generate force values based on input data derived from the sensor output(s). Feature vector logic 314 generates input vectors from the digitized sensor output(s). It is these input vectors that are used by microprocessor 306 in conjunction with the sensor model data in memory 312 to generate the force values. As will be described, the features represented in the input vectors and the weights applied to those features may vary considerably from application to application.

Referring again to FIG. 1, system components are depicted that are configured to generate one or more machine learning models representing the behavior of the one or more sensors on substrate 104, e.g., sensor S1. For the sake of simplicity, the training process by which a machine learning model is generated will be described with reference to a single sensor but, as will be appreciated, the process may be applied to multiple sensors, and one or more models may be generated for each. Moreover, it should be noted that implementations are contemplated in which sensor model data for a class of devices or systems may be generated based on the training of one or a small number of such devices or systems. Implementations are also contemplated in which each such device or system is trained which may include, for example, training by an end user that generates the sensor model data and/or supplements previously generated sensor model data.

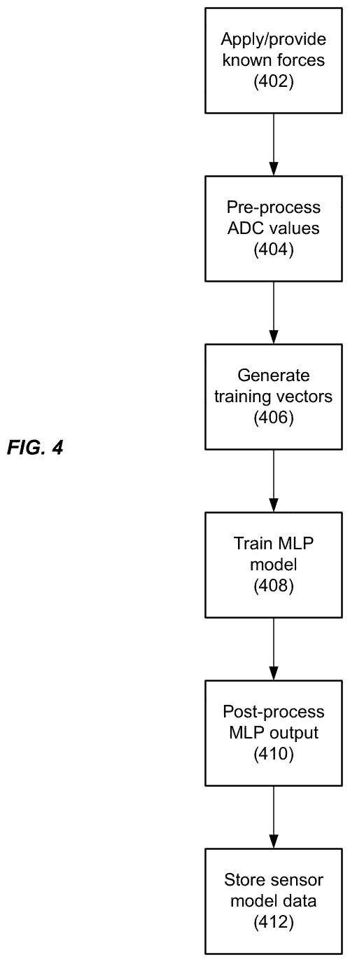

The training data set for the machine learning model for sensor S1 results from force application system 130 applying time-varying pressure to sensor S1, with these known forces also being provided to machine learning algorithm 132 operating on any suitable computing device (represented by a laptop in this example). System 130 might be implemented, for example, using a controllable pneumatic piston the size of the sensor which is resting on a force plate. The operation of a particular class of implementations of algorithm 132 is represented by the flowchart depicted in FIG. 4.

It should be noted that, despite any references to particular computing paradigms and software tools herein, the computer program instructions on which various implementations are based may correspond to any of a wide variety of programming languages, software tools and data formats, may be stored in any type of non-transitory computer-readable storage media or memory device(s), and may be executed according to a variety of computing models including, for example, a client/server model, a peer-to-peer model, on a stand-alone computing device, or according to a distributed computing model in which various functionalities may be effected or employed at different locations.

Referring now to FIG. 4, the known forces are applied to the sensor and provided to the machine learning algorithm (402). The raw ADC values resulting from application of the forces to the sensor are processed (404) to make the resulting data more linear and to take better advantage of the full range of the ADC (which might be, for example, a 10-bit ADC). This processing allows for better machine learning, allowing for multiple training sessions or training data sets with varying activation styles, as well as data collection from sensors with differing dynamic ranges. This processing effectively “stretches” the data so that the machine learning algorithm has more resolution for tuning its model(s). That is, the more linear the data, the better the algorithm will be able to relate the input data to the desired output data. According to some implementations, any of the linearization methods that come with machine learning packages may be employed for this purpose. For example, some such methods are based on statistical analyses such as, for example, limiting the variance of the data to between one and minus one. Examples include ordinary least squares, the lasso progression, the multitask lasso, etc. Terrace does preprocessing as well. However, there are some implementations for which such methods (which are typically applied to very large data sets) are too cumbersome from a computational perspective.

According to a particular class of implementations, the raw ADC values are processed using a relatively simple exponential equation to stretch out the data. According to a particular implementation, a fourth power equation is used. One example is the equation y(i)=i⁴/r⁴*s, in which i is the ADC value (e.g., ranging from 1 to 1024), r is the resolution of the ADC (e.g., 1024), and s is a normalizing constant that places the data in the desired range for the particular application. Implementations are also contemplated in which a simply squaring equation might be used instead.

The processed ADC values are then used to generate training vectors (406). The features included in such training vectors may vary considerably from application to application. That is, the nature of the features included in these training vectors and the way the features are weighted can vary considerably depending on the nature of the forces expected. For example, the features included for a drum might differ in significant ways from those included for a wearable device such as an insole or data glove.

In one illustrative example, the features in the training vectors that are derived from the ADC values are represented by [S₀, S₋₁₀, S₋₆₀₀, S₀-S₋₁], in which each S refers to a particular ADC value at a certain point in time represented by the index, i.e., S₀ is the current sample, S₋₁ is the previous sample, S₋₁₀ is 10 samples in the past, and S₋₆₀₀ is 600 samples in the past. In this example, the feature set also includes the difference between the current and previous samples. As will be appreciated, the number and spacing of these samples will vary depending on the application.

Most training vectors will typically include S₀ as that is the current sample. The timing, spacing, and/or weighting of other ADC values are likely to be application dependent. For example, with a drum, the expectation is that the forces will be characterized a fast attack time. So, the difference (or derivative) between consecutive samples might be more heavily weighted in the vector. The feature set for drum might even have several such delta features using closely based samples. In another example, older inputs might be useful for applications in which prolonged force is expected (e.g., an insole) in that this will help account for things like creep and pumping (repeated on-off pressure cycles). So, for example, features like S₋₁₀ and S₋₆₀₀ might useful for such applications so that the machine learning algorithm recognizes that the sensor has been in use for a while.

More generally, the feature set for the training vectors (and runtime input vectors) includes different ADC values at different time intervals. The interval(s) between samples and the number of samples might be different for different applications. The feature set may also include other information relating to the context of the sensor, e.g., temperature, pressure, humidity, etc.

For each training vector the machine learning algorithm trains a multi-layer perceptron (MLP) model that the vector corresponds to a known force (408). This process, conducted using many applications of force over ranges of the features in the vectors, results in a sensor model as represented by sensor model data that map each set of conditions (as embodied by the structure of the vector representation of the inputs) to a particular force value. The result is a lookup table or similar mechanism stored in memory of the device or system that maps current ADC values to force values using the various data in the resulting input vectors (e.g., previous value(s), derivative(s), temperature, etc. These data effectively represent one or more sensor models, with each entry representing a force value for the conditions that index to that entry.

As will be appreciated, the features included in the training and input vectors may be similar across applications with the variability of each (or at least some) of the features being constrained to the particular use case or application. And as mentioned above, depending on the application, a sensor model might be developed for all similar devices or systems based on the training of just one or very few devices or systems. Alternatively, a unique model might be generated for each specific device or system. In some cases (e.g., a sensor glove), an end user might do some or all of the generation and/or training of the model. By contrast, an embedded system (e.g., an occupant classification system or OCS in a vehicle) might employ a single model to govern operation of all instances of that system type.

According to a particular implementation, the machine learning algorithm starts with a blank neural net with 6 weights and 14 hidden layers, i.e., 84 neurons, and trains the MLP model using few minutes of 10 Hz data. The algorithm runs all the weights through, tunes the weights, checks if they worked, makes adjustments, and repeats the process until it reaches a tolerance (e.g., within 1%) relative to the known values for multiple runs in a row. As will be appreciated, both the tolerance and the number of runs meeting the tolerance may be varied depending on the scope of the project. The size of the training set and the number of features in the training vectors may also vary depending on the time available to get the model(s) to converge.

According to some implementations, post-processing (e.g., filtering) may be performed to handle noise at the output of the neural net (410). Such processing might involve, for example, running a moving average on the neural net output to correct for short-term anomalous movement in the signal, e.g., smoothing. According to a particular implementation, post-processing includes tracking the rate of change of the neural net output and if, for example, the rate goes from a big delta to a slow rate, the force value output may be locked to a current value. The sensor model data are then stored (e.g., in a table in sensor device memory) for use at run time (412).

According to a particular class of implementations, devices or systems enabled by the present disclosure may include router and state machine (RSM) logic configured to configure the data processing pipeline of the device or system at run time. For example, for implementations in which the sensor model data in memory represents multiple sensor models, the RSM logic would choose between models to process the input vectors. For example, for a wearable sensor system such as an insole, one model might be used for long distance running and another model for sprinting. Based on the nature of the input being received, the RSM logic detects what is happening and then uses the appropriate model, e.g., by selecting the force value table used.

The RSM may also route the output of the selected sensor model to different post-processing mechanism such as, for example, the adaptive filtering mechanism or locking mechanism described above. If the received sensor data are dynamic (e.g., a drum is being played), the RSM logic might select adaptive filtering for post-processing of the data. On the other hand, if the data are static (e.g., the drum is not being played or a weight has been placed on the drum), the RSM logic might select the locking mechanism.

According to a particular implementation, the first filter is an exponential weighted average (EWMA) operating on the output of the neural net, correcting for transient noise. The EWMA equation is shown below, with p₁ as the most recent reading and p₂ the second most recent and so on:

$$EWMA = \frac{{p}_{1} + ( 1 - α ) * {p}_{2} + {( 1 - α )}^{2} * {p}_{3} + {( 1 - α )}^{3} * {p}_{4} + …}{1 + ( 1 - α ) + {( 1 - α )}^{2} + {( 1 - α )}^{3} + …}$$

The alpha in this equation is calculated using a half-life, i.e., the number of terms it will take to be one half of the original weight. For example, in the case of a 20 item buffer, a half-life of 10 is used.

$$α = 1 - exp ( \frac{log ( 0.5 )}{halflife} )$$

The second filter operates on a buffer of pre-preprocessed samples from the preprocessing stage, before entry into the neural net. This filter serves as the locking mechanism as selected by the RSM logic. The filter takes the mode of the buffer of samples and, if the mode is below a given threshold, the output from the neural net is passed into the EWMA filter and used as the system output. If the mode is greater than or equal to the threshold, the system output (from the neural net through the EWMA filter) is locked to a chosen historical value.

More generally, the RSM logic is configured to recognize particular states (e.g., a static state like something sitting on the drum or a dynamic state like the drum being struck) and then select the sensor model(s) and/or post-processing that are most appropriate for the recognized states. Using the initial inputs, the RSM logic enables different operational modes for a device or system, configuring the appropriate processing pipeline from among a number of possible processing pipelines thus allowing for accurate force reporting over a range of conditions and sensor behavior that may not be easily captured by a single model or corrected with a single set of filters.

Reconfiguration of the processing pipeline by the RSM logic might also be useful after a period of use to account for thing like changes in the sensor's behavior due to things like viscoelastic creep. That is, the RSM logic might recognize that certain types of inputs over a certain period of time might require use of a different model or different filtering based on changes in sensor behavior that occurs as a result of such use over such a time period (e.g., as represented by corresponding thresholds being triggered).

According to some implementations, RSM logic may determine whether it is necessary to continue populating input vectors with new data. For example, if the RSM logic detects that something like temperature isn't changing, the RSM logic would hold to the current model being used but if the temperature were to change drastically, the RSM logic might switch to a different model which might have different pre-processing filters, model parameters, post-processing filters, or any combination of these.

It will be understood by those skilled in the art that changes in the form and details of the implementations described herein may be made without departing from the scope of this disclosure. In addition, although various advantages, aspects, and objects have been described with reference to various implementations, the scope of this disclosure should not be limited by reference to such advantages, aspects, and objects. Rather, the scope of this disclosure should be determined with reference to the appended claims.

What is claimed is:

1. A device, comprising:
a sensor, the sensor including a component characterized by a nonlinear characteristic; and
sensor circuitry configured to receive a sensor signal from the sensor, the sensor signal representing a force on the sensor, the sensor circuitry including memory having sensor model data stored therein, the sensor model data representing a sensor model, the sensor model representing sensor behavior that reflects the nonlinear characteristic of the component, the sensor circuitry being configured to generate a force value based on the sensor signal and the sensor model data, the force value representing the force on the sensor.

2. The device of claim 1, wherein the sensor model represents the sensor behavior over one or more of a range of temperature, a range of pressure, or a range of humidity.

3. The device of claim 1, wherein the sensor model data are stored in a table that relates digital representations of the sensor signal to force values, and wherein the sensor circuitry is configured to generate the force value by selecting the force value from the table based on at least one digital representation of the sensor signal.

4. The device of claim 1, wherein the sensor circuitry is configured to generate a plurality of digital values based on the sensor signal over time, and wherein the sensor circuitry is configured to generate the force value based on a current digital value of the plurality of digital values and a previous digital value of the plurality of digital values.

5. The device of claim 4, wherein the previous digital value corresponds to a most recent time at which a previous force above a specified threshold was exerted on the sensor.

6. The device of claim 4, wherein the sensor circuitry is configured to generate the force value based on a difference between the current digital value and the previous digital value.

7. The device of claim 1, wherein the sensor circuitry is configured to generate the force value based on a temperature value representing a temperature.

8. The device of claim 1, wherein the sensor model data represent a plurality of sensor models, and wherein the sensor circuitry includes logic configured to select one of the sensor models for generation of the force value based on a state derived from the sensor signal.

9. The device of claim 1, wherein the sensor circuitry includes a filter and logic configured to select or modify the filter for generation of the force value based on a state derived from the sensor signal.

10. The device of claim 1, wherein the sensor circuitry is configured to generate a plurality of digital values based on the sensor signal over time, and wherein the sensor circuitry is configured to generate the force value by locking the force value to a previously generated force value if a statistical characteristic of a set of the digital values exceeds a threshold.

11. The device of claim 1, wherein the sensor circuitry is configured to generate a plurality of digital values based on the sensor signal over time, and wherein the sensor circuitry is configured to generate the force value by applying a scaling function to digital values.

12. The device of claim 1, wherein the nonlinear characteristic of the component comprises viscoelasticity.

13. A method, comprising:
exerting known forces on a sensor of a sensor type, the sensor including a component characterized by a nonlinear characteristic;
receiving digital values resulting from the known forces;
generating training vectors using the digital values;
training a machine learning algorithm using the training vectors and the known forces, thereby resulting in sensor model data representing a sensor model, the sensor model representing sensor behavior that reflects the nonlinear characteristic of the component; and
storing the sensor model data in a memory of a device that includes an instance of the sensor type.

14. The method of claim 13, further comprising applying a linearizing technique to the digital values before generating the training vectors.

15. The method of claim 14, wherein the linearizing technique includes an exponential scaling function.

16. The method of claim 13, further comprising determining a plurality of states based on the digital values, wherein training the machine learning algorithm results in the sensor model data representing a plurality of sensor models, each sensor model corresponding to one of the states.

17. The method of claim 13, wherein the training vectors include a plurality of features, and wherein training the machine learning algorithm includes determining weights for each of the features such that the sensor model data associate force values with each of the training vectors that accurately represent the corresponding known forces within a specified tolerance.

18. The method of claim 13, wherein each training vector includes a current digital value of the digital values and a previous digital value of the digital values.

19. The method of claim 18, wherein each training vector also includes a difference between two of the digital values.

20. The method of claim 18, wherein each training vector also includes a temperature value representing a temperature.

21. The method of claim 18, wherein the previous digital value corresponds to a most recent time at which one of the known forces above a specified threshold was exerted on the sensor.

22. The method of claim 13, wherein the nonlinear characteristic of the component comprises viscoelasticity.
